(19) United States
(12) Patent Application Publication
(10) Pub. No.: US 2024/0329201 A1
(43) Pub. Date: Oct. 3, 2024

(54) SIMULATOR FOR THE SIMULATION OF A DISTANCE FOR SENSORS, METHOD FOR OPERATING SUCH A SIMULATOR AND A DELAY SECTION FOR SUCH A SIMULATOR

(71) Applicant: dSPACE GmbH, Paderborn (DE)

(72) Inventor: Andreas HIMMLER, Paderborn (DE)

(73) Assignee: dSPACE GmbH, Paderborn (DE)

(21) Appl. No.: 18/621,356

(22) Filed: Mar. 29, 2024

(30) Foreign Application Priority Data
Mar. 30, 2023 (DE) 10 2023 108 197.7

(51) Int. Cl. G01S 7/40; G01S 7/497

(52) U.S. Cl. CPC G01S 7/4065; G01S 7/497

(57) ABSTRACT

A simulator for the simulation of a distance for sensors (radar, LIDAR). The simulator includes a receiver, which is set up to receive a first sensor signal from the sensors (radar, LIDAR) and convert it into a work signal. A delay section with a plurality of delay lines is applied to at least one substrate. A first electrical switching device, which is set up to switch a first selection of delay lines as a function of a first selection signal in such a way that a signal path for the work signal includes the first selection. A transmitter is set up to convert the work signal into a second sensor signal after running through the signal path and send it to the sensors (radar, LIDAR). A method for operating the simulator and a delay section for the simulator are also provided.

This nonprovisional application claims priority under 35 U.S.C. § 119 (a) to German Patent Application No. 10 2023 108 197.7, which was filed in Germany on Mar. 30, 2023, and which is herein incorporated by reference.

### BACKGROUND OF THE INVENTION

### Field of the Invention

The application relates to a simulator for the simulation of a distance for sensors, a method for operating the simulator and a delay section for the simulator.

### Description of the Background Art

A simulator for the simulation of a distance for sensors that is supposed to measure the distance reproduces this distance and is used, for example, to test the sensors. Sensors that are intended to measure a distance is also referred to as distance sensors.

From WO 2020/141151 A1, which corresponds to U.S. 2022/0082658, which is incorporated herein by reference, a method for operating a simulator device for testing distance sensors working with electromagnetic waves is known. In this method, a desired reflection signal is generated according to a signal received by the distance sensors, which is provided with a frequency shift. From the added frequency shift, the distance sensors can obtain information about a relative velocity. The distance sensors can be tested by means of the simulator device.

From WO 2020/136279 A1, which corresponds to U.S. 2022/0120856, which is incorporated herein by reference, a signal delay device for simulating spatial distances for distance sensors based on electromagnetic waves is known. In this method, a desired reflection signal is generated according to a signal received by the distance sensors, which is provided with a delay. From the added delay of the received signal, the distance sensors can obtain distance information. The distance sensors can be tested by means of the simulator device.

### SUMMARY OF THE INVENTION

It is therefore an object of the invention to provide a simulator for the simulation of a distance for sensors that has a receiver that is set up to receive a first sensor signal from the sensors and convert it into a work signal. Furthermore, the simulator has a delay section. The delay section has a plurality of delay lines applied to at least one substrate and a first electrical switching device. The first electrical switching device is set up to switch a first selection of delay lines as a function of a first selection signal in such a way that a signal path for the work signal includes the first selection. The simulator also has a transmitter that is set up to convert the work signal into a second sensor signal after running through the signal path and send it to the sensors.

By means of the first selection signal, the simulator makes it possible to precisely switch a selectable and predetermined distance via the delay section, thus enabling a suitable simulation for the sensors. In particular with regard to the function of autonomous driving, in which the sensors for distance measurement play a prominent role, the precise simulation of the distance for these sensors is necessary for testing and checking the sensors.

The simulator can be a device with electrical, electronic and mechanical components. For example, mechanical integration of the sensors into the simulator can be realized by means of a receptacle. The simulator also has control functions and, for example, an input terminal for one person to be able to control the simulations. In addition, the simulator has functions that are implemented in software technology and that can run automatically after being triggered.

The simulation of a distance is a cost-effective way to test sensors for distance measurement, because simulating the distances in the experiment, e.g., by an object at the corresponding real distance, is a time-consuming and cost-intensive activity.

For example, the sensors can be environment sensors based on electromagnetic waves, such as radar, video or LIDAR. However, other sensors measuring distances are also suitable, such as ultrasonic sensors.

The receiver can be an electrical or electronic device that is set up to receive the first sensor signal originating from the sensors and convert it into a work signal. For this purpose, the receiver has, for example, an antenna or comparable receiving elements. These convert the received signal, such as a radar signal, into a work signal, which the receiver transmits, e.g., by wire to a delay section.

The delay section includes a plurality of delay lines applied to a substrate. This makes it possible, for example, to easily implement a large number of different delay lines using simple structuring techniques. Individually or, for example, interconnected, these delay lines can be used to simulate a wide variety of distances. As a function of the first selection signal, a selection of delay lines is then switched via the first switching device in such a way that a signal path for the work signal includes this first selection, i.e., the delay lines simulating the desired distance have been determined by the first selection. The work signal then runs through these selected delay lines. The signal path therefore defines the currently selected delay line or the currently selected delay lines. Furthermore, the simulator includes a transmitter that is set up to convert the work signal into a second sensor signal after running through the signal path and send it to the sensors. This second sensor signal is supposed to simulate a signal reflected on an object, wherein the distance was simulated by delay lines. Therefore, the second sensor signal is designed in such a way that it can be received by a sensor receiver, such as a radar or LIDAR receiver, and evaluated accordingly. This makes it possible to test the functionality of the sensors.

The delay section can be designed to have a plurality of electrical cables and a second switching device, wherein the second switching device is designed as an electrical switching device. The second switching device is set up to switch a second selection of delay lines as a function of a second selection signal in such a way that the signal path for the work signal includes the second selection in addition to the first selection. The second selection has electrical cables as delay lines. This makes it possible to use delay lines with electrical cables in addition to the delay lines applied to the substrate. With the delay lines applied to the substrate, very precise and short distances can be selected, while with the electrical cables, longer distances are easier to realize.

The delay section can have a plurality of optical cables and an electrooptical switching device, wherein the electrooptical switching device is designed to switch a third selection of optical cables as a function of a third selection signal, in such a way that the signal path for the work signal includes the third selection at least in addition to the first selection. This means that, in addition to the delay lines applied to a substrate and the optional electrical cables, a delay is also possible via selected optical cables. For this purpose, the work signal can be converted from an electrical signal into an optical signal and can also be converted back into an electrical signal after running through the selected optical cables for the transmitter. Optical cables make it easier to recreate larger distances than the delay lines on the substrate, so all three can be used to recreate larger distances very accurately.

The receiver can have a first transducer, which is set up to receive the electromagnetic waves emitted by the sensors, which form the first sensor signal, in a first frequency range and convert them into a work signal in a second frequency range. In doing so, the receiver can transform the received electromagnetic signals into a lower frequency range for the work signal in order to facilitate electrical or electronic transmission and processing of the work signal.

It is possible that the first frequency range is around 77 GHz and the second frequency range is between one and 3 GHz or around 1.5 GHz or around 2.5 GHz.

The substrate can be a printed circuit board. On printed circuit boards, delay lines can be efficiently formed using structuring techniques.

At least some of the delay lines, and in particular the optical cables, can be designed as waveguides.

An attenuator can be provided that is designed to attenuate the amplitude of the work signal as a function of a fourth selection sign and/or a frequency change unit is provided which is set up to change the frequency of the work signal as a function of a fifth selection signal. This makes it possible to realistically respond to certain objects or properties of the environment, by which, for example, a radar signal or LIDAR signal is reflected.

A method for operating the simulator, in which the distance for sensors is simulated by means of a delay section, can comprise the following method steps: receiving a first sensor signal emitted by the sensors by a receiver of the simulator, wherein the first sensor signal is converted into a work signal; running through a first selection of delay line through the work signal as a function of a first selection signal, wherein the delay lines are formed on at least one substrate and a first electrical switching device switches a first selection as a function of the first selection signal, in such a way that the signal path for the work signal includes the first selection; and converting the work signal into a second sensor signal and sending it to the sensors.

A delay section for the simulator can comprise the following: a receiving interface for receiving a work signal, a plurality of delay lines applied to at least one substrate, and a first electrical switching device that is set up to switch a first selection of the delay line, as a function of a first selection signal, in such a way that the signal path for the work signal includes the first selection.

The simulator can optionally be designed to simulate multiple objects that have different delays in the second sensor signal. For this purpose, the simulator can have several signal paths, in which respective delay sections are provided for respective delays.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows, an overall arrangement of a radar with a simulator,

FIG. 2 shows a block diagram of the simulator in communication with the radar,

FIG. 3 shows another block diagram of the simulator in communication with the radar,

FIG. 4 shows another block diagram of the simulator in communication with a LIDAR,

FIG. 5 shows a schematic representation of the delay lines applied to a substrate,

FIG. 6 shows a flow diagram of the method, and

FIG. 7 shows another block diagram of the simulator with additional influence on the amplitude and frequency of the work signal.

### DETAILED DESCRIPTION

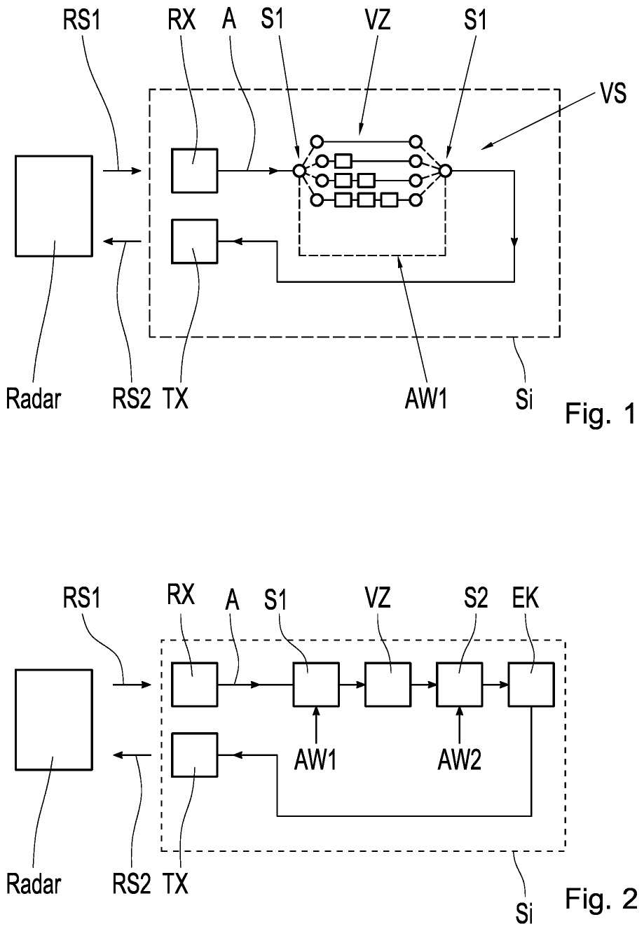

FIG. 1 shows a block diagram of the simulator Si in communication with a radar sensor Radar. In this case, communication means that electromagnetic signals are exchanged over the air between the radar sensor Radar and the simulator Si.

The radar sensor Radar transmits a first radar sensor signal RS1, which is received by the simulator Si with a receiver RX and is converted into a work signal A. For example, the receiver RX has a heterodyne receiver. The work signal A is transmitted via a first switching device S1 to a corresponding delay line VZ. For this purpose, a first selection signal AW1 is applied to the first switching device S1, which instructs the switching device S1 to switch the corresponding delay line VZ or the corresponding delay lines VZ for the work signal A, so that the work signal A runs through these delay lines VZ according to the first selection AW1. The delay lines VZ, which are crossed by the work signal A, form the signal path. The entirety of the delay lines VZ form the delay section VS. The delayed signal A is then sent to a transmitter TX, which converts the delayed work signal A into a second sensor signal RS2 and sends it to the radar sensor Radar.

In particular, the delay lines VZ can be electrical cables applied to substrate Sub. The first switching device S1 can therefore preferably be designed as an electrical switching device, especially in the form of semiconductor switches. Relays or microelectromechanical MEMS switching devices are also conceivable.

FIG. 2 shows the simulator Si in another block diagram, supplemented by another possibility of delaying the work signal A, namely with electrical cables EK. In order to select the desired delay for the electrical cables EK, the selection signal AW2 is applied to a second switching device S2. The second switching device S2 is preferably designed as an electrical switching device S2. The signal path for the work signal A is thus formed by the delay lines VZ applied to the substrate Sub and by the corresponding electrical cables EK. In turn, the delayed work signal A is then sent to the radar sensor Radar via the transmitter TX as a second sensor signal RS2.

In the example shown in FIG. 2, the first switching device S1, which has at least one delay line VZ, the second switching device S2 and at least one electrical cable EK form the delay section VS.

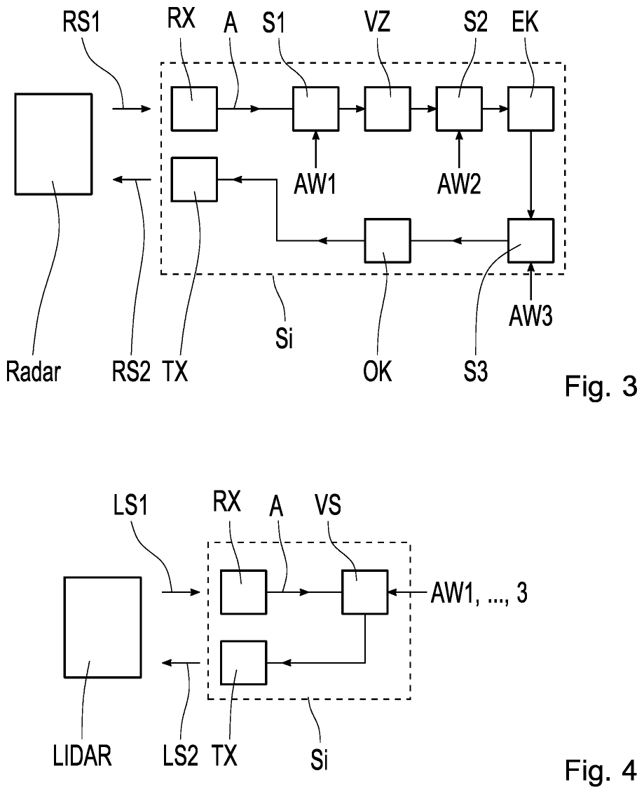

FIG. 3 shows another example of the simulator Si, namely a third way to switch delays into the signal path for the work signal A. It is possible to use a third selection signal AW3 to instruct a third switching device S3 to switch optical cables OK into the signal path in order to achieve a certain delay through these optical cables OK. To do this, the work signal A must be converted into an optical signal in order to run through the optical cables OK. This requires electrooptical transducers that generate an optical work signal A from the electrical work signal A.

The third switching device is preferably designed as an optical switching device and can be designed, for example, as an optical MEMS device.

After running through the optical cable OK, a conversion into an electrical signal takes place. An optical-electrical converter may be provided for conversion. The electrical work signal A is sent to the radar sensor Radar via the transmitter TX as a second sensor signal RS2.

In the example shown in FIG. 3, the first switching device S1, the at least one delay line VZ, the second switching device S2, the at least one electrical cable EK, the third switching device S3 and the at least one optical cable OK form the delay section VS.

FIG. 4 shows the simulator Si in another block diagram, which is now in communication with a LIDAR sensor. The first sensor signal LS1 is light emitted by the LIDAR sensor LIDAR, which is converted into the work signal A by the receiver RX. The work signal A is preferably an electrical signal.

Again, as shown in FIGS. 1-3, the corresponding possibilities for forming the signal path for the work signal A are offered by the delay section VS, i.e., the selection signals AW1, AW2 and AW3 are used to select the corresponding delay lines VZ and the other optional electrical and/or optical cables EK, OK. The work signal A, which has run through these delay lines VZ as a signal path, is then converted into the second sensor signal LS2 via the transmitter TX in order to be sent back to the LIDAR sensor LIDAR.

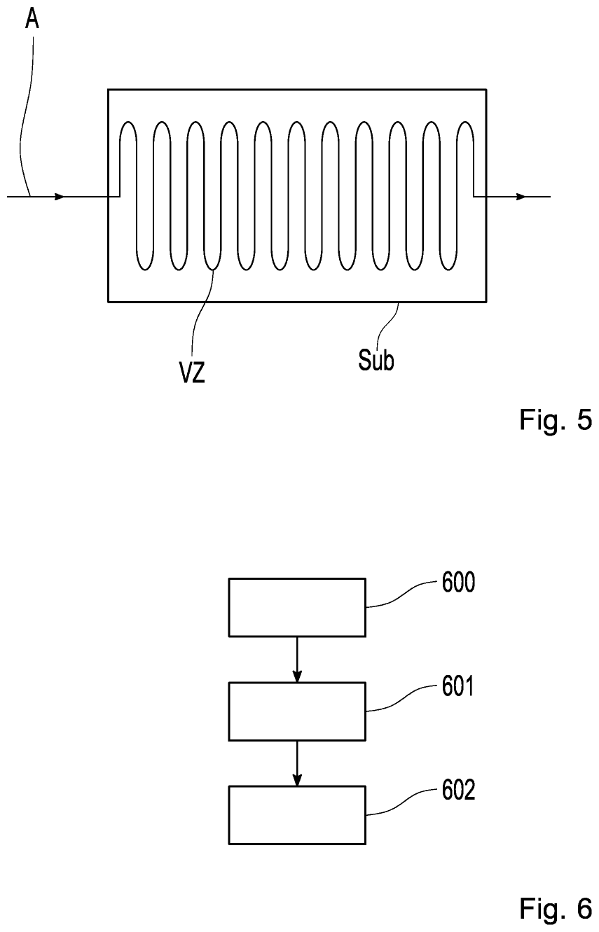

FIG. 5 shows a simple example of a delay line VZ applied to a substrate Sub. For this purpose, the work signal A runs through a wave-shaped conductor on a substrate Sub, which acts as a delay line VZ and thus causes a corresponding delay. Such an example enables a space-saving and thus cost-effective implementation of a delay line VZ.

FIG. 6 shows, in a flowchart, the method for operating the simulator Si. In method step 600, the first sensor signal RS1 is received by the receiver RX and converted into the work signal A. In method step 601, the corresponding or desired delay lines VZ are selected by the selection signals AW1, AW2 and/or AW3. The work signal A then runs through the signal path formed in this way, which occurs in method step 602. The delayed work signal A is then sent back as a second sensor signal RS2 to the sensors Radar under test.

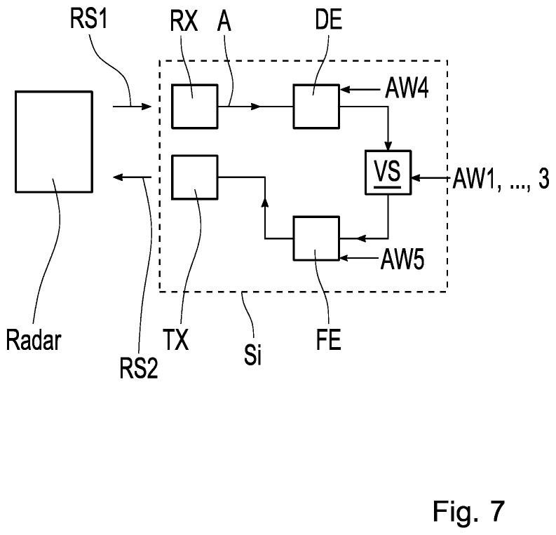

In a further block diagram, FIG. 7 shows the structure of the simulator Si in communication with the radar sensor Radar, wherein, in addition to applying a delay to the work signal A through the delay section VS, it is also possible to change the amplitude and frequency of the work signal A in the simulator Si.

The first sensor signal RS1 sent by the radar sensor Radar is received by the receiver RX. The receiver RX converts the first sensor signal RS1 into the work signal A. The work signal A is supplied to an attenuator DE via a cable, which can be influenced by a fourth selection signal AW4 in such a way that the fourth selection signal AW4 determines the level of attenuation by the attenuator DE. The attenuation influences the amplitude of the work signal A and, consequently, the amplitude of the second sensor signal RS2. From the amplitude of the second sensor signal RS2, the sensors Radar can obtain information about the size of the object on which the reflection of the first sensor signal RS1 is simulated in the present case.

The level of attenuation can be influenced in stages and/or continuously. For example, different resistors can be switched on and/or a potentiometer can be used. For this purpose, the attenuator has one or more switching devices that are actuated as a function of the fourth selection signal AW4. This is followed by the delay section VS, which, as a function of the first and/or second and/or third selection signal AW1-3, adds a corresponding delay to the work signal A, which is determined by the selection signals AW1-3.

Then, the work signal A is fed to a frequency changer FE, which changes the frequency of the work signal A as a function of a fifth selection signal AW5. For this purpose, e.g., a voltage-controlled oscillator can be used, which provides a frequency by which, e.g., the frequency of the work signal A is increased or decreased. This can be done by multiplying the work signal A by the signal from the oscillator. From the frequency of the work signal A, and as a result of the second sensor signal RS2, the sensors Radar can obtain information about the relative velocity of the object on which the reflection of the first sensor signal RS1 is simulated, e.g., by using the Doppler effect.

The components DE, FE and VS shown do not have to be present in the order shown, but instead can also be presented in a different order. It may be that only the attenuator DE or only the frequency changer FE is present.

The work signal A, which is then altered in this way, is converted into the second sensor signal RS2 by the transmitter TX and sent back to the radar sensor Radar as a radar signal.

FIG. 7 illustrates the simulator using an example of radar sensors Radar. Accordingly, the simulator Si can also be used for other environment sensors, such as LIDAR.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A simulator to simulate a distance for at least one sensor, the simulator comprising:
a receiver to receive a first sensor signal from the at least one sensor and convert the received first sensor signal into a work signal;
a delay section with a plurality of delay lines applied to at least one substrate;
a first electrical switch to switch a first selection of delay lines as a function of a first selection signal such that a signal path for the work signal includes the first selection;
a transmitter to convert the work signal into a second sensor signal after running through the signal path and to send the second sensor signal to the at least one sensor.

2. The simulator according to claim 1, wherein the delay section has a plurality of electrical wires and a second electrical switching device, wherein the second electrical switching device switches a second selection of the electrical wires as a function of a second selection signal such that the signal path for the work signal includes the second selection.

3. The simulator according to claim 1, wherein the delay section includes a plurality of optical cables and an electro-optical switching device, wherein the electro-optical switching device switches a third selection of the optical cables as a function of a third selection signal such that the signal path for the work signal includes the third selection.

4. The simulator according to claim 1, wherein the receiver has a first transducer to receive the electromagnetic waves emitted by the at least one sensor, which form the first sensor signal in a first frequency range, and converts them into a work signal in a second frequency range.

5. The simulator according to claim 4, wherein the first frequency range is about 77 GHz and the second frequency range is between 1 GHz and 3 GHz or about 1.5 GHz or about 2.5 GHz.

6. The simulator according to claim 1, wherein the substrate is a printed circuit board.

7. The simulator according to claim 1, wherein at least some of the delay lines are designed as waveguides.

8. The simulator according to claim 1, further comprising:
an attenuator to attenuate the work signal with respect to its amplitude as a function of a fourth selection signal; and/or
a frequency changer to change the work signal as a function of a fifth selection signal with respect to its frequency.

9. A method for operating the simulator according to claim 1, in which the distance for the at least one sensor is simulated via a delay section, the method comprising:
receiving a first sensor signal emitted by the at least one sensor by a receiver of the simulator;
converting the first sensor signal being converted into a work signal;
running through a first selection of delay lines by the work signal as a function of a first selection signal, the delay lines being formed on at least one substrate and a first electrical switching device switching the first selection as a function of the first selection signal such that a signal path for the work signal includes the first selection;
converting the work signal into a second sensor signal and sending the second sensor signal to the at least one sensor.

10. The method according to claim 9, wherein a plurality of electrical cables is provided, and wherein a second switching device switches a second selection of the electrical cables as a function of a second selection signal such that the signal path for the work signal includes the second selection.

11. The method according to claim 10, wherein a plurality of optical cables is provided, and wherein an electro-optical switching device switches a third selection of the optical cables as a function of a third selection signal such that the signal path for the work signal includes the third selection.

12. The method according to claim 10, wherein the receiver has a first transducer, which receives the electromagnetic waves emitted by the at least one sensor, which waves form the first sensor signal in a first frequency range, and converts them into a work signal in a second frequency range.

13. The method according to claim 12, wherein the first frequency range is about 77 GHZ and the second frequency range is between 1 GHz and 3 GHz or about 1.5 GHz or about 2.5 GHz.

14. The method according to claim 10, wherein an attenuator attenuates the work signal with respect to its amplitude as a function of a fourth selection signal and/or wherein a frequency changer changes the work signal with respect to its frequency as a function of a fifth selection signal.

15. A delay section for a simulator according to claim 1, the delay section comprising:
a receiving interface for receiving a work signal;
a plurality of delay lines applied to at least one substrate; and
a first electrical switching device set up to switch a first selection of delay lines as a function of a first selection signal such that the signal path for the work signal includes the first selection.

16. The simulator according to claim 1, wherein the at least one sensor is radar or LIDAR sensors.
